(19) United States
(12) Patent Application Publication
(10) Pub. No.: US 2018/0081345 A1
(43) Pub. Date: Mar. 22, 2018

(54) WORK IN PROCESS MANAGEMENT SYSTEM AND METHOD

(71) Applicant: General Electric Company, Schenectady, NY (US)

(72) Inventors: Marc Philippe MAILMAN, San Ramon, CA (US); Michael WHITE, San Ramon, CA (US); Cynthia DECKER, San Ramon, CA (US)

(21) Appl. No.: 15/446,565

(22) Filed: Mar. 1, 2017

Related U.S. Application Data
(60) Provisional application No. 62/397,463, filed on Sep. 21, 2016.

(51) Int. Cl. G05B 19/418

(52) U.S. Cl. CPC G05B 19/41865; G05B 2219/32389

(57) ABSTRACT

Provided are a system and method for managing work in process at a manufacturing site. In one example, a management device includes an interface to receive a request for a work order that includes one or more components for manufacture, a processor to determine a manufacturing progress of the work order, and determine a time at which the work order is to be completed based on the manufacturing progress of the work order and a status at least one work queue associated with manufacturing at least one remaining component of the work order, and an output to display a work in process (WIP) report of the work order including the time at which the work order is to be completed. According to various aspects, the predicted time of completion for a work order can be provided at the time the work order is placed or soon thereafter.

### CROSS-REFERENCE TO RELATED APPLICATIONS

The present application claims the benefit under 35 USC §119(e) of U.S. Provisional Patent Application No. 62/397,463, filed on Sep. 21, 2016, the entire contents of which are hereby incorporated by reference for all purposes.

### BACKGROUND

Work in process (WIP) which may also be referred to as work in progress, goods in process, in-process inventory, and the like, refers to a manufacturer's partially finished inventory of goods and products that are in process but awaiting completion. For example, a product that is halfway completed might be represented as having a WIP progress of 50%. The amount of WIP inventory is often reported along with raw materials and finished goods on a manufacturer's balance sheet as a current asset. But the longer a piece of work is considered a work in process (and not completed) the more the work can interfere with the production of the plant. Furthermore, if work in process accumulates at one work center before being shifted to a next work center, a series of flawed units (e.g., partially manufactured goods with flaws) could build up before being discovered at the next work center. As a result, production expediters may force certain crucial jobs through the built up pile of work in process jobs, which can throw the production system into an even greater muddle. Instead, work in process should move between work centers in small amounts (e.g., one unit at a time) with very little inventory piling up between work stations. Ideally, a lean production environment should contain a small enough amount of work-in-process inventory that the amount on hand may be immaterial.

Managing work in process is not easy. In particular, keeping track of work in process and determining if an order will be late, how much longer an order will take, if there is going to be a significant backlog, and the like, can be a difficult if not impossible task. Without physically walking a plant floor it is difficult to ascertain where a work order currently is within the plant. It can also be difficult to ascertain when orders will be processed at individual work centers within the plant. In some cases, operators may tend to work on the easiest orders first, improving their individual production performance but making it difficult to prioritize orders in real-time. Indirect labor at the plant may also be high because of a lack of coordination in material management. The plant floor can be crammed with materials for future orders or have significant “starve” downtime where materials needed for an order are not present making it difficult to gauge work in process based on raw materials, alone. It can also be difficult to visualize capacity versus actual work queues. Accordingly, what is needed is a system that can manage work in process and provide plant floor visibility for heavy industry.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings, in which:

FIG. 1 is a diagram illustrating a system for managing work in process in a manufacturing environment in accordance with an example embodiment.

FIG. 2 is a diagram illustrating an architecture of a cloud-based manufacturing system in accordance with an example embodiment.

FIG. 3 is a diagram illustrating a user interface displaying work in process at a manufacturing site in accordance with an example embodiment.

FIGS. 4-7 are diagrams illustrating user interfaces displaying a work in process report in accordance with example embodiments.

FIG. 8 is a diagram illustrating a method for managing a manufacturing process in accordance with an example embodiment.

FIG. 9 is a diagram illustrating a management device for managing a manufacturing process in accordance with an example embodiment.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order not to obscure the description with unnecessary detail. Thus, the present disclosure is not intended to be limited to the embodiments shown, but is to be accorded the widest scope consistent with the principles and features disclosed herein.

The example embodiments are directed to a work in process (WIP) manager, for example, a work management system, device, software application, and the like, which is capable of reducing work in process at a manufacturing plant or site and making it possible to increase schedule adherence, lower working capital, and improve overall plant operations. The WIP manager may increase material visibility (e.g., movement of materials) through the plant, ensure that the right materials are at the right place at the right time, and optimize a supply chain. From a point in time at which a work order is received or soon thereafter, the WIP manager can predict when the order will be finished based on the individual parts included in the work order and a monitored status of the plant including the individual work centers that will be processing the work order. The WIP manager may provide visualization of order queues at work stations, visualization of working capital cost locations, and material level alerts/actions. The WIP manager may also provide highlighting of slow or stuck orders, estimated time of arrival (ETA) on orders based on the progress of the orders, a real-time material tracker with historical genealogy, and order subscriptions such as push notifications on order updates. The WIP manager may detect and track material movement through the plant using simple and non-time intensive data collection techniques (e.g., RFID, barcode, etc.), and ERP integration for orders, routings, BOMs, and the like.

Brilliant Manufacturing Suite (BMS) is a cloud-based platform that was recently released in an effort to better optimize manufacturing. At its heart, the software applies real-time analytics to help improve decision-making across all aspects of the manufacturing chain to optimize processes and materials, cut costs and waste involved in rework, improve designs, minimize unscheduled asset downtime, and bring new products to market faster. The suite has modules including a performance analyzer module that turns machine data into efficiency metrics, a production execution supervisor to digitize orders, process steps, instructions, and documentation with information from ERP and product lifecycle management systems, a production quality analyzer to identify quality data boundaries and catch non-conforming events before they occur, and a product genealogy manager that automatically builds records of all personnel, equipment, raw materials, sub-assemblies, and tools used to produce finished goods. The example embodiments may be incorporated or otherwise implemented with brilliant manufacturing.

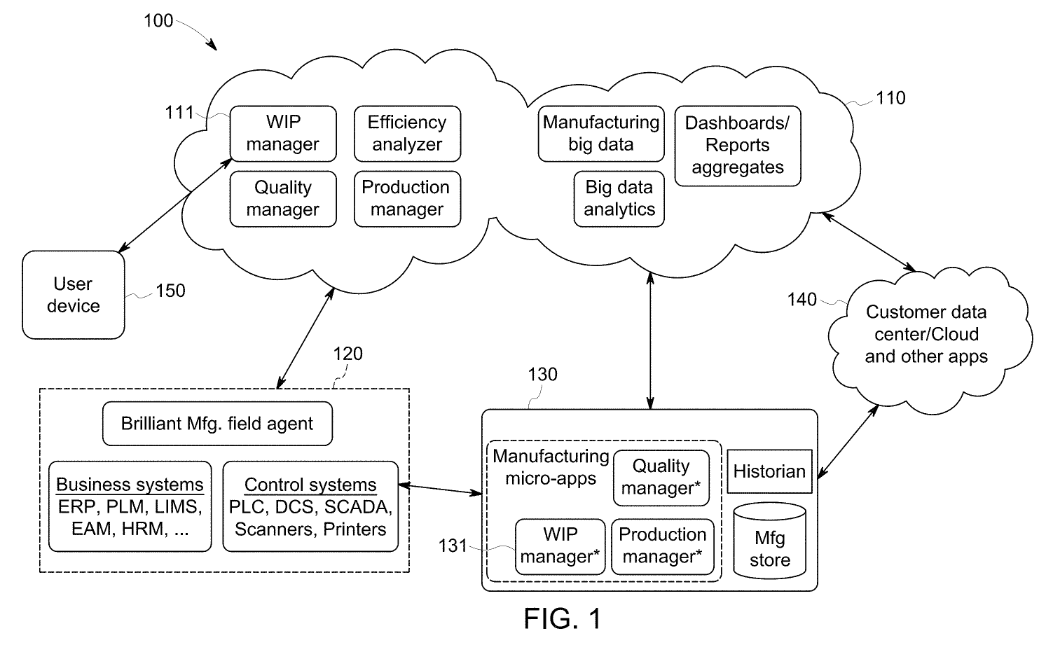

FIG. 1 illustrates a system 100 for managing work in process in a manufacturing environment in accordance with an example embodiment. Referring to FIG. 1, the system 100 includes a cloud platform 110 which may store data and services for the manufacturing environment, plant, system, etc., including data, analytics, work orders, reports. In addition to the data and services, the cloud platform 110 may include various applications executing or associated therewith for monitoring and analyzing work in process within the manufacturing environment, for example, a work in process (WIP) manager 111 as well as a quality manager, an efficiency analyzer, a production manager, and others. The system 100 also includes a control system 120, an edge system 130, and a customer data center 140. The cloud platform 110, the control system 120, the edge system 130, and the customer data center 140 of the system 100 may be connected to each other through a wired connection and/or through a network connection such as a public network (e.g., the Internet) or a private network. Also in some examples, one or more of the cloud platform 110, the control system 120, the edge system 130, and the customer data center 140 may be incorporated together with one another on the same device or system. Although not shown in FIG. 1, it should be appreciated that the system 100 may include other devices, components, and even systems not shown.

The control system 120 may include one or more business systems such as ERP, PLM, LIMS, EAM, HRM, and the like. The control system 120 may also include one or more control systems such as PLC, DCS, SCADA, and hardware devices (e.g., printers, scanners, copiers, networked devices, workstations, and the like). The control system 120 may be included at the manufacturing site, in the cloud, at another remote location, or a combination thereof. The control system 120 may be associated with a field agent such as a brilliant manufacturing field agent. The edge system 130 may include devices and equipment of the manufacturing site such as computing devices, sensors, workstations, and the like, for monitoring the components of the manufacturing site (work centers, workstations, production line, assembly line, etc.) and sending information to the cloud platform 110 and the control system 120 where it may be further analyzed. For example, the edge system 130 may be an extension of the cloud platform 110, it may include existing edge devices on premise, a combination thereof, and the like, and may have capabilities deployed based on type of manufacturing being performed at the site (e.g., aircraft, locomotive, power, automotive, electrical, mechanical and other heavy industry), speed, criticality, security, manufacturer preference, and the like. The customer data center 140 may include various manufacturing data, applications, and the like, for use by the manufacturing site. The customer data center 140 may be included on premise, in the cloud platform 110, or a combination thereof, and may receive APIs and data feeds from the cloud platform 110.

In this example, a WIP manager 131 is included at the premise of the manufacturing site in the edge system 130 and communicates with the WIP manager 111 included in the cloud platform 110. For example, the WIP manager 131 may be an extension of the WIP manager 111 or it may be a separate instance. According to various aspects, manufacturing data may be transmitted between the WIP manager 131 at the edge and WIP manager 111 in the cloud such that the cloud platform 110 can receive data about the manufacturing plant such as information about work orders, work centers, work queues associated with the work centers, output, and the like. Based on this information transmitted to the cloud platform 110, other applications at the cloud platform 110 may analyze the data and provide various controls and analytics. For example, the cloud platform may improve efficiency in production at the manufacturing site, manage quality, manage production, and the like, based on one or more applications and services included in the cloud platform. Furthermore, the WIP manager 111 may improve efficiency of the work in process by identifying work centers which have more availability and less of a backlog, distributing work based on availability, identify materials that should be ordered to satisfy upcoming orders, order the materials, and the like.

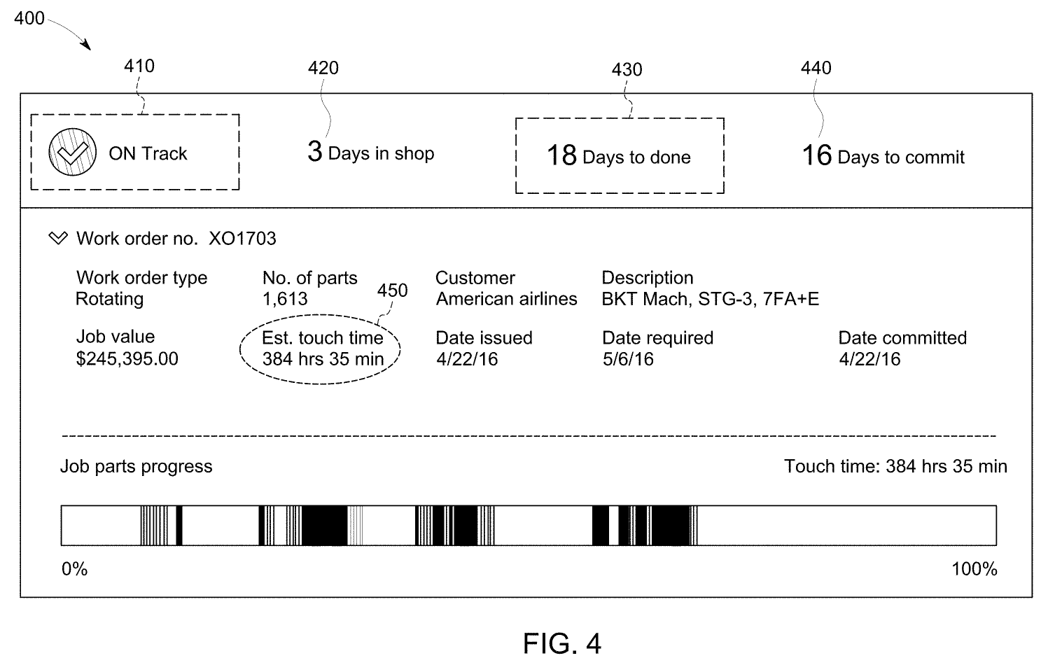

According to various embodiments, the WIP manager 111 and/or WIP manager 131 may provide a user interface (such as shown in FIGS. 4-7) which provides information about work in process at a manufacturing site. For example, the user interface may be provided to a computing device (e.g., workstation, tablet, mobile device, and the like) of a technician, manager, engineer, and the like, at manufacturing site. As another example, the user interface may be provided to a user device 150 corresponding to a client, a customer, a user, an administrator, or the like. The user device may be a computer, a laptop, a tablet, a mobile device, a kiosk, an appliance, a workstation, a server, and the like. The user interface provided to the user device 150 may include information about manufacturing progress of a work order including an estimated time of delivery of a work order, work queue information about work centers expected to process the work order, planned hours at the work centers, and the like. Furthermore, the user interface may further break down a work order into each part included in the work order and provide manufacturing progress information about each respective part.

According to various aspects, the WIP manager may provide a significant benefit to a manufacturing site because the WIP manager can provide a visual display (e.g., a digital interface) to manufacturers showing the progress, location, and estimated time of completion for all of their work in process. In some examples, the WIP manager can even provide this information directly to a customer. The WIP manager may provide additional benefits because the WIP manager may provide a status of a plurality of work centers that are going to be processing the work order, an alert for slow or stuck orders, a material level alert, an estimated processing time for each part in the work order, a predicted date of delivery, a change in an amount of time remaining on a work order based on change in processing of a part thereof, a user interface/portal for the customer and the engineers to access the WIP manager, an average queue time (wait time) at each work center, an amount of planned work (work to complete) at each work center, and the like.

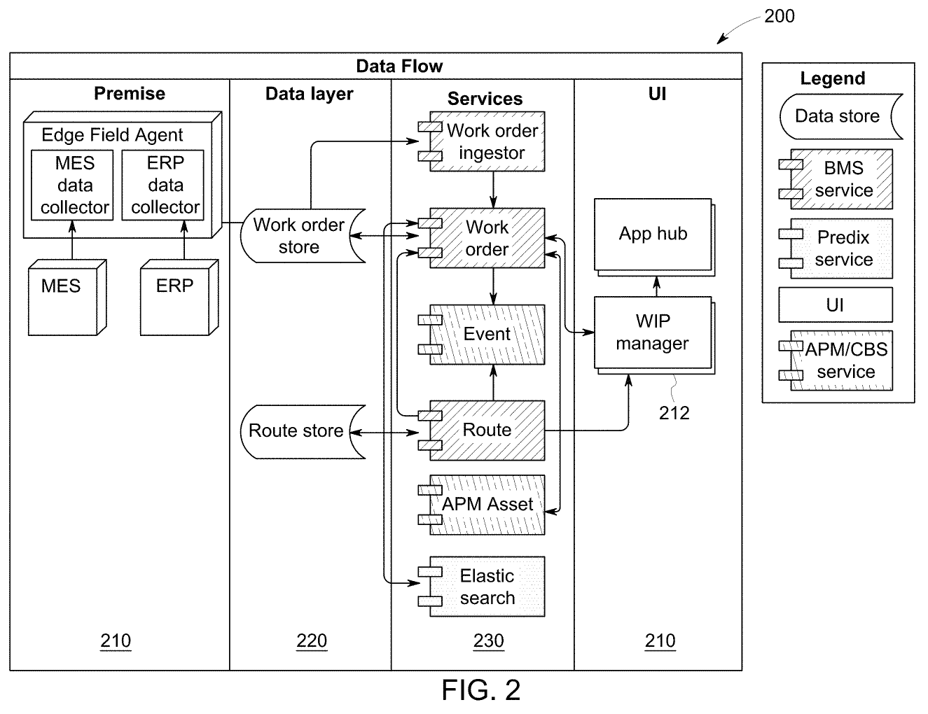

FIG. 2 illustrates an architecture 200 of a cloud-based manufacturing system in accordance with an example embodiment. Referring to FIG. 2, the architecture 200 includes a plurality of layers including a premise layer 210 that represents applications installed at a manufacturing site (e.g., plant, rig, etc.), a data layer 220 representing data collected from the premise layer 210, a services layer 230 for performing services on the data, and a user interface layer 240 providing a visual representation of the data and which may be hosted by a cloud environment. It should also be appreciated that the data layer 220 and the services layer 230 may be stored in the cloud or in a separate device connected to the cloud. In this example, WIP manger 212 is included in the user interface layer 240 along with an app hub application. The app hub may control the interaction between the user interface layer 240 and the premise of the manufacturing site by providing a user with access to data and services in the data layer 220 and the service layer 230. Furthermore, the WIP manager 212 may receive data from the premise layer 210 via one or more of the service layer 230 and the data layer 220 based on work in process at the manufacturing site. For example, the WIP manager 212 may receive information about work orders, work centers, planned hours, processing efficiency, and the like, from one or more services in the service layer 230 and display the information through a u UI in the user interface layer 240.

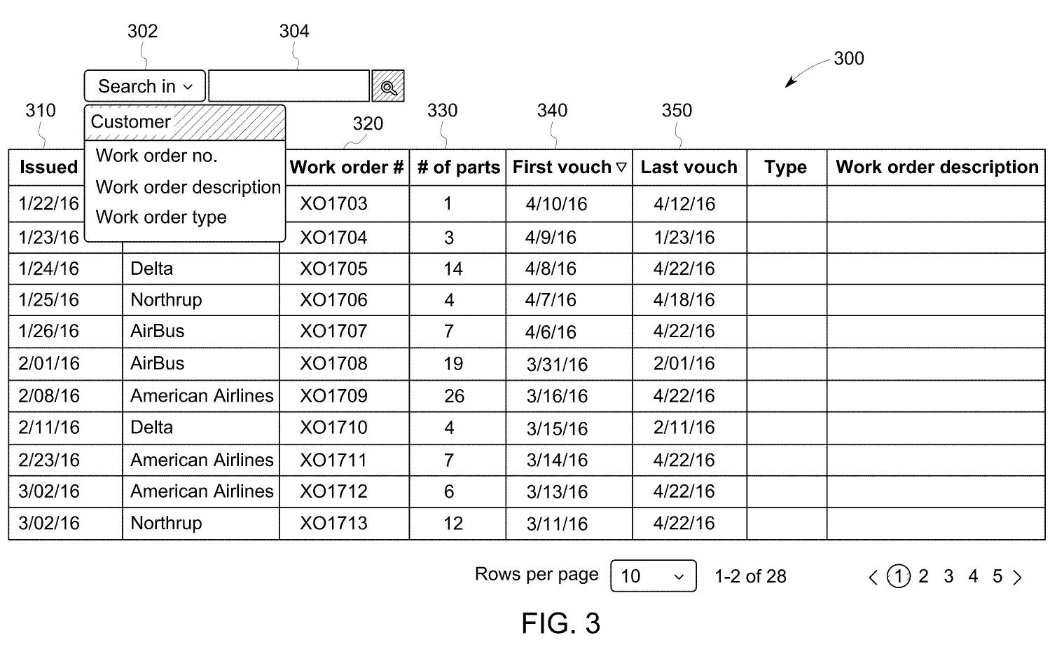

FIG. 3 illustrates a user interface 300 displaying work in process at a manufacturing site in accordance with an example embodiment. For example, the user interface 300 may be displayed at a workstation of an engineer or administrator of a manufacturing plant, a device of a remote engineer or remote administrator located remotely from the manufacturing site but connected to the manufacturing site through a network, cloud, and the like. As another example, the user interface 300 may be displayed at a user device (e.g., a customer or other user) that is connected to the manufacturing site via a network, cloud, and the like.

In this example, the user interface 300 includes a listing of work in process at a manufacturing site or plant. Here, the user interface 300 includes a search tab 302 and a search bar 304 capable of receiving information input by a user. For example, the user may select a particular field of the work in process and enter alphanumeric text into the search bar in order to search for a specific part, work order, description, type, etc. The work in process includes a plurality of rows and a plurality of columns where each row represents a respective work order and each column represents an element associated with the work order. For example, column 310 indicates a data at which the work order was received, column 320 identifies the work order by name, column 330 indicates the number of parts included in a respective work order, column 340 indicates a first vouch for the work order, and column 350 indicates a last vouch for the work order. There are also columns that may be used to enter type information and work order description. In this example, the user may select any of the work orders to further drill down into additional information about a respective work order as shown in the examples of FIGS. 4-7.

FIGS. 4-7 illustrate examples of user interfaces displaying a work in process (WIP) report in accordance with example embodiments. FIG. 4 illustrates a WIP report associated with a work order 400 including a plurality of parts and an identified work order number. For example, work order 400 may be displayed in response to a user making a selection of a work order from the user interface 300 shown in FIG. 3. In the example of FIG. 4, the work order 400 includes a work in process status of the work order 410 which indicates that the work order 400 is currently “on track.” The work order 400 also includes an amount of time in shop 420 representing the amount of time in days since the work order has been received, an amount of time until completed 430 representing an amount of time in days until the work order will be completed, and an amount of time to commit 440, representing an amount of work still left to be done. In addition the visual representation of the work order 400 includes an estimated touch time 450, as well as other values such as type of work order, description, data required, date issued, and the like. Furthermore, the work order 400 also includes a visual graph at the bottom thereof indicating the progress of the individual jobs of the work order 400. In this example, the work order includes 1,613 parts.

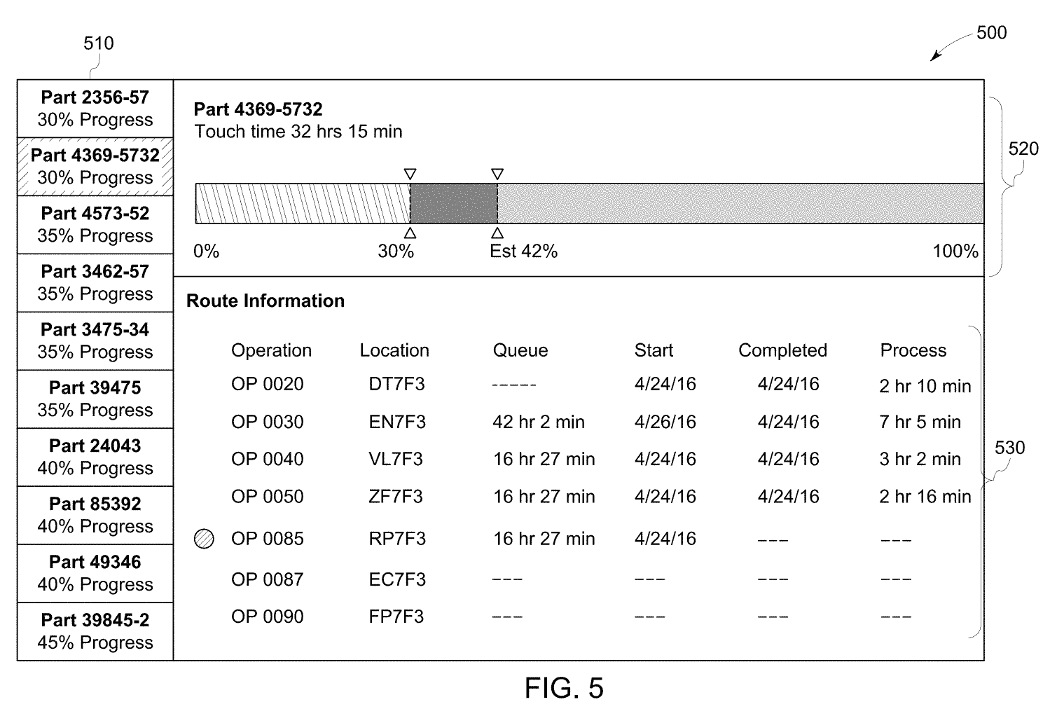

FIG. 5 illustrates a WIP report associated with a WIP report 500 associated with a plurality of parts included in a work order. For example, the WIP report 500 may be displayed in response to a selection (e.g., selecting time until completed 430, time to commit 440, no. of parts, job parts progress bar, or the like) via the work order 400 screen shown in FIG. 4. In this example, a navigation panel 510 displays a listing of all the parts associated with a work order along with a progress status of each part. A user may use the navigation panel 510 to select a part from the list and drill down into additional information about the respective part. In this example, Part 4369-5732 has been selected via the navigation panel 510. Here, part information 520 further expands on the information about Part 4369-5732 and includes a bar graph illustrating the estimated manufacturing progress of the part, a touch time of the part, and the like. Also included for the selected part is route information 530 showing the operations remaining for the part as well as each work station (location/queue) where the operation will be, or has been performed. In addition, the route information 530 also includes information about a start time and an end time of the operation of each part as well as a total processing time of the operation.

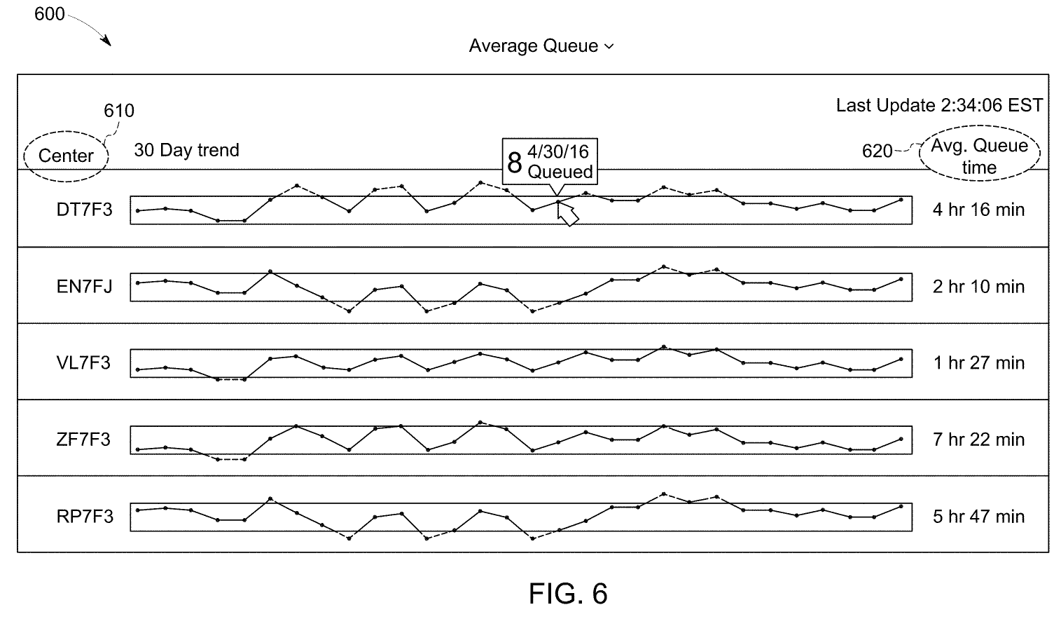

FIG. 6 illustrates a WIP report 600 associated with average queue time at a plurality of work stations for processing a respective part or work order. In this example, each work station is identified by a center 610 and an average queue time 620 is provided for the respective center. Also shown is a visual graph showing the change in average queue time over a predetermined period of time (e.g., 30 days). A user may highlight an area of the visual graph of a work center and receive additional information about the work center at a day or period of time at which the user's cursor is located on the graph. In this example, the cursor is located at a point in the graph corresponding to Apr. 30, 2016, and the user is provided a number of jobs performed at the queue that day.

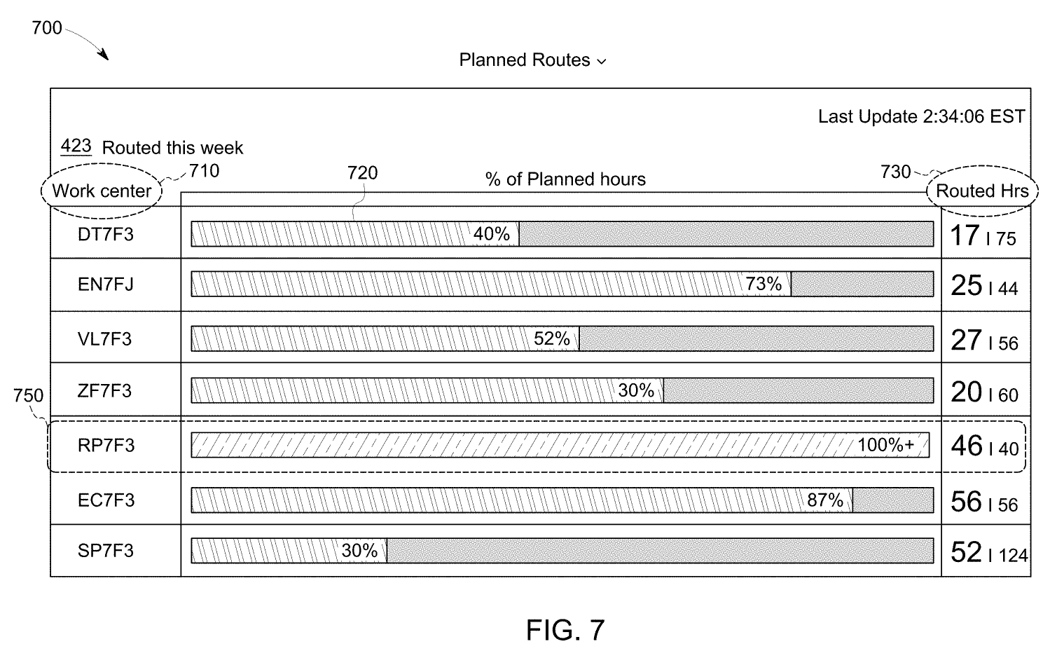

FIG. 7 illustrates a WIP report 700 associated with the number of planned (i.e., scheduled) hours at each work center. In this example, each work center is identified by work center column 710. Also, for each work center, provided is a ratio 720 of planned hours versus available hours represented by a bar graph, and a number of routed hours versus available hours 730. Accordingly, a viewer can see how many hours are planned for each work center that will be processing part of a part or a work order. This information can be used by the WIP manager to redirect processing jobs. Also, in 750 a work center that is behind is illustrated with a warning (e.g., a different color). Accordingly, the WIP report 700 can provide a visual indication to the user that a work center is slow or stuck.

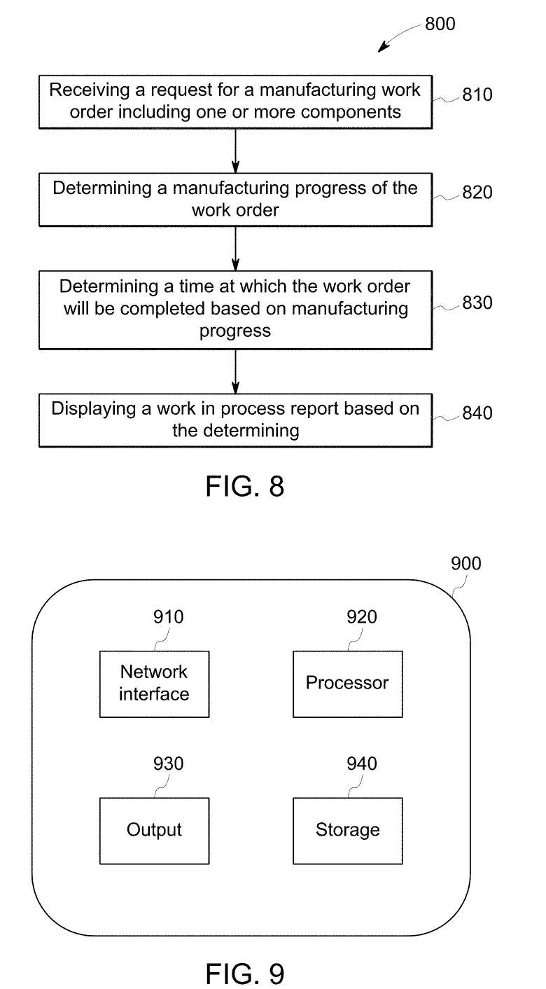

FIG. 8 illustrates a method 800 for managing a manufacturing process in accordance with an example embodiment. For example, the method 800 may be performed by the WIP manager 111 and/or the WIP manager 131 shown in FIG. 1, or it may be performed by another device. Referring to FIG. 8, in 810 the method includes receiving a request for a work order that includes one or more components for manufacture. For example, the work order may be a work order for a group of parts that are related to one another, a plurality of units, a plurality of widgets, and the like. The work order may have information about a customer for who the work order is being built, a time/data at which the work order was received, materials that will be or are being used to build the parts included in the work order, and the like.

According to various embodiments, in 820 the method includes determining a manufacturing progress of the work order. The manufacturing progress may indicate an amount of time remaining until the work order is completed, how many work centers still need to perform an operation on a part from the work order, and the like. In some examples, the manufacturing progress may include an amount of planned hours assigned but not yet performed by each work center/work queue associated with the work order. In 830, the method includes determining a time at which the work order is to be completed based on the manufacturing progress of the work order and based on a status at least one work queue associated with manufacturing at least one remaining component of the work order. In 840, the method further includes displaying a work in process (WIP) report of the work order including the time at which the work order is to be completed. According to various embodiments, the determining in 820 and/or 830 may include determining an estimated time at which manufacturing of the work order will be completed, an estimated time of delivery when the parts from the work order will be delivered to the customer, information about work centers at a manufacturing site that are working on the work order including average queue time and planned hours at each work center, and the like. As another example, the determining the time at which the work order is to be completed in 830 may be determined based on historical data of related work orders previously manufactured. For example, the related work order may be a work order that has one or more parts that overlap parts included in a current work order. As another example, the related work order may include a same work order previously manufactured by the manufacturing site for the same customer, a previous work order from the same customer having different parts, and the like.

The WIP report generated in 840 may display information about any and all of these features determined in 820 and 830 to enable a user (e.g., a customer) to visualize a status of the work order including a work in process status. For example, the work order may include a plurality of components to be manufactured. In this example, the determining the manufacturing progress of the work order in 820 may include determining a manufacturing progress of each respective component (e.g., part) of the work order, the determining of the time at which the work order is to be completed in 830 may be determined based on the status of each part determined in 820, and the displaying the WIP report in 840 may include displaying the manufacturing progress of each respective component. As another example, the determining the manufacturing progress in 820 may further may include determining a status of a plurality of work queues associated with manufacturing one or more remaining components of the work order, the determining of the time at which the work order is to be completed in 830 may be determined based on the status of each of the plurality of work queues determined in 820, and the displaying the WIP report in 840 may include displaying the status of each of the plurality of work queues.

There may be a situation that occurs causing a status of a work in process of a work order to change, for example, a delay in another work order, a lack of materials, an unforeseen malfunction at a plant, a power outage, and the like. Therefore, the method may further include changing the time at which the work order is to be completed based on at least one of a change in the manufacturing progress of the work order and a change in a status at least one work queue associated with manufacturing at least one remaining component of the work order, and changing the displaying of the WIP report of the work order based on the changed time at which the work order is to be completed. Furthermore, the method may further include detecting a component of the work order that is delayed based on an amount of time that the component has been at a work queue, and displaying an alert corresponding to the delayed component.

FIG. 9 illustrates a management device 900 for managing a manufacturing process in accordance with an example embodiment. For example, the management device 900 may correspond to one or more of the WIP managers 111 and 131 shown in FIG. 1, or another device, and may be capable of performing the method 800 shown and described with respect to FIG. 9. Referring to FIG. 9, the management device 900 includes a network interface 910, a processor 920, an output 930, and a storage 940. The network interface 910 may transmit and receive data to and from other devices through a network such as the Internet, a private network, public network, and the like. The processor 920 may include one or more processing devices each having one or more processing cores. The processor 920 may control the overall operations of the management device 900. The output 930 may output a user interface to a display device such as a display device of the management device 900 or a display device of an externally connected device or cloud connected device. The storage 940 may store information about manufacturing data received from a manufacturing site such as work orders, parts, materials, work center information, and the like.

In this example, the network interface 910 may receive a request for a work order that includes one or more components for manufacture. The processor 920 may determine a manufacturing progress of the work order, and determine a time at which the work order is to be completed based on the manufacturing progress of the work order and a status at least one work queue associated with manufacturing at least one remaining component of the work order received from one or more cloud based devices at the manufacturing site or received from other sources. The output 930 may display a work in process (WIP) report of the work order including the time at which the work order is to be completed. The storage 940 may store the WIP reports.

In some examples, a work order corresponding to the request received by the network interface 910 may include a work order having a plurality of components to be manufactured. In this example, the processor 920 may determine a manufacturing progress of each respective component of the work order, and generate a WIP report including the manufacturing progress of each respective component which may be output by the output 930. In some examples, the processor 920 may determine a status of a plurality of work queues associated with manufacturing one or more remaining components of the work order, and the WIP report displayed by the output 930 further include the status of each of the plurality of work queues. In some examples, the processor 920 may determine the time at which the work order is to be completed based on historical data of related work orders previously manufactured. In addition, the WIP report may include a predicted date of delivery of the work order and an amount of hours remaining on the work order.

According to various embodiments, the processor 920 may change the time at which the work order is to be completed based on at least one of a change in the manufacturing progress of the work order and a change in a status at least one work queue associated with manufacturing at least one remaining component of the work order, and the output 930 may output a change to the WIP report corresponding to the work order based on the changed time at which the work order is to be completed. In some examples, the processor 920 may detect a component of the work order that is delayed based on an amount of time that the component has been at a work queue, and the output 930 may display an alert corresponding to the delayed component. As another example, the WIP report may include one or more of an amount of planned hours assigned but not yet performed by each work queue associated with the work order, an average processing time at each queue, an identification of a plurality of operations to be performed at on a particular part at each queue, and the like.

According to various example embodiments, described herein is a system and method for managing work in process for manufacturing. The examples herein provide a user interface that provides a user with real-time information about a manufacturing plant, for example, information about work centers, information about materials, information about processing speed, and the like. Furthermore, the system is capable of providing an estimated time of completion for a work order as well as each part included in the work order well in advance (e.g., from the time the work order is placed or shortly thereafter). Accordingly, without physically walking a plant floor it is possible to ascertain how much time is left on a work order at any given point in time.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and/or any transmitting/receiving medium such as the Internet, cloud storage, the internet of things, or other communication network or link. The article of manufacture containing the computer code may be made and/or used by executing the code directly from one medium, by copying the code from one medium to another medium, or by transmitting the code over a network.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable medium” and “computer-readable medium” refer to any computer program product, apparatus, cloud storage, internet of things, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described in connection with specific examples, it should be understood that various changes, substitutions, and alterations apparent to those skilled in the art can be made to the disclosed embodiments without departing from the spirit and scope of the disclosure as set forth in the appended claims.

What is claimed is:

1. A management device for managing a manufacturing process, the management device comprising:
a network interface configured to receive a request for a work order that includes one or more components for manufacture;
a processor configured to determine a manufacturing progress of the work order, and determine a time at which the work order is to be completed based on the manufacturing progress of the work order and a status at least one work queue associated with manufacturing at least one remaining component of the work order; and
an output configured to display a work in process (WIP) report of the work order including the time at which the work order is to be completed.

2. The management device of claim 1, wherein the work order comprises a plurality of components to be manufactured,
the processor is further configured to determine a manufacturing progress of each respective component of the work order, and
the WIP report displayed by the output further comprises the manufacturing progress of each respective component.

3. The management device of claim 1, wherein the processor is configured to determine a status of a plurality of work queues associated with manufacturing one or more remaining components of the work order, and the WIP report displayed by the output further comprises the status of each of the plurality of work queues.

4. The management device of claim 1, wherein the processor is further configured to determine the time at which the work order is to be completed based on historical data of related work orders previously manufactured.

5. The management device of claim 1, wherein the WIP report comprises a predicted date of delivery of the work order and an amount of hours remaining on the work order.

6. The management device of claim 1, wherein the processor is further configured to change the time at which the work order is to be completed based on at least one of a change in the manufacturing progress of the work order and a change in a status at least one work queue associated with manufacturing at least one remaining component of the work order, and
the output is further configured to change the WIP report of the work order based on the changed time at which the work order is to be completed.

7. The management device of claim 1, wherein the processor is further configured to detect a component of the work order that is delayed based on an amount of time that the component has been at a work queue, and the output is further configured to display an alert corresponding to the delayed component.

8. The management device of claim 1, wherein the WIP report further comprises an amount of planned hours assigned but not yet performed by each work queue associated with the work order.

9. A method for managing a manufacturing process, the method comprising:
receiving a request for a work order that includes one or more components for manufacture;
determining a manufacturing progress of the work order;
determining a time at which the work order is to be completed based on the manufacturing progress of the work order and a status at least one work queue associated with manufacturing at least one remaining component of the work order; and
displaying a work in process (WIP) report of the work order including the time at which the work order is to be completed.

10. The method of claim 9, wherein the work order comprises a plurality of components to be manufactured,
the determining the manufacturing progress of the work order comprises determining a manufacturing progress of each respective component of the work order, and
the displaying the WIP report further comprises displaying the manufacturing progress of each respective component.

11. The method of claim 9, wherein the determining the manufacturing progress further comprises determining a status of a plurality of work queues associated with manufacturing one or more remaining components of the work order, and the displaying the WIP report further comprises displaying the status of each of the plurality of work queues.

12. The method of claim 9, wherein the determining the time at which the work order is to be completed is further determined based on historical data of related work orders previously manufactured.

13. The method of claim 9, wherein the displaying the WIP report further comprises displaying a predicted date of delivery of the work order and an amount of hours remaining on the work order.

14. The method of claim 9, wherein the method further comprises changing the time at which the work order is to be completed based on at least one of a change in the manufacturing progress of the work order and a change in a status at least one work queue associated with manufacturing at least one remaining component of the work order, and
changing the displaying of the WIP report of the work order based on the changed time at which the work order is to be completed.

15. The method of claim 9, further comprises detecting a component of the work order that is delayed based on an amount of time that the component has been at a work queue, and displaying an alert corresponding to the delayed component.

16. The method of claim 9, wherein the displaying the WIP report further comprises displaying an amount of planned hours assigned but not yet performed by each work queue associated with the work order.

17. A non-transitory computer readable medium having stored therein instructions that when executed cause a computer to perform a method for managing a manufacturing process, the method comprising:
receiving a request for a work order that includes one or more components for manufacture;
determining a manufacturing progress of the work order;
determining a time at which the work order is to be completed based on the manufacturing progress of the work order and a status at least one work queue associated with manufacturing at least one remaining component of the work order; and
displaying a work in process (WIP) report of the work order including the time at which the work order is to be completed.

18. The non-transitory computer readable medium of claim 17, wherein the displaying the WIP report further comprises displaying a predicted date of delivery of the work order and an amount of hours remaining on the work order.

19. The non-transitory computer readable medium of claim 17, wherein the work order comprises a plurality of components to be manufactured,
the determining the manufacturing progress of the work order comprises determining a manufacturing progress of each respective component of the work order, and
the displaying the WIP report further comprises displaying the manufacturing progress of each respective component.

20. The non-transitory computer readable medium of claim 17, wherein the determining the manufacturing progress further comprises determining a status of a plurality of work queues associated with manufacturing one or more remaining components of the work order, and the displaying the WIP report further comprises displaying the status of each of the plurality of work queues.
